(19) United States
(12) Patent Application Publication
(10) Pub. No.: US 2005/0030602 A1
(43) Pub. Date: Feb. 10, 2005

(54) Scan templates

(76) Inventors: Daniel P. Gregson, Boise, ID (US); Robert Sesek, Meridian, ID (US); Chad A. Stevens, Boise, ID (US); Michael J. Shelton, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/635,197

(22) Filed: Aug. 6, 2003

(51) Int. Cl. H04N 1/04; H04N 1/46

(52) U.S. Cl. 358/505; 358/474

(57) ABSTRACT

The present invention provides methods and a scan template including a media sheet having printed thereon a figure and a machine-readable identifier disposed on the media sheet specifying a size, shape, and location on the sheet of the figure.

### FIELD OF THE INVENTION

The present invention relates generally to scanning.

### BACKGROUND

Scanners scan images, such as photographs, drawings, text documents, etc., and convert the images into digital data. Scanners send the digital data to a processor that usually converts the data into a bitmap or similar data format. The bitmap is often converted to a formatted data file, such as Portable Document Format (PDF), Tag Image File Format (TIFF), Joint Photographic Experts Group (JPEG), or other data format. For one application, a scanner is a computer peripheral connected to a computer, and the computer acts as the processor. For other applications, a scanner is an integral component of a digital transmitter, such as digital sender, digital network copier, multi-function peripheral, etc., that includes the processor.

For some applications, a plurality of hardcopy images are scanned simultaneously by positioning the plurality of hardcopy images on the scanner at once. An electronic representation is created for each scanned image. The electronic representation for each scanned image is then cropped to remove non-image areas, such as white space. The cropped images can then be stored and/or sent to various destinations, such as electronic mail (email) addresses, facsimile (fax) destinations, network printers, personal computers, or other data receiving devices.

For one cropping method, an algorithm surveys a scan for white space surrounding the images and crops the white space out. This is sometimes erratic when dealing with images with a white background, such as printed materials or certain photos. For another cropping method, a user does a preview scan and then manually designates a crop area, e.g., with a pointing device, such as a mouse. Then, the user does a follow-up scan in which software uses the user's defined area to crop the scanned image. This makes scanning a large number of photos tedious and time consuming. For some cropping methods, the user manually crops out each hardcopy image, saving and reloading the full scan for each crop. This is tedious and time consuming and may involve compressing data corresponding to an image twice, which can result in data loss.

### SUMMARY

One embodiment of the present-invention provides a scan template including a media sheet having printed thereon a figure and a machine-readable identifier disposed on the media sheet specifying a size, shape, and location on the sheet of the figure.

### DESCRIPTION OF THE DRAWINGS

FIG. 1 illustrates a scan template according to an embodiment of the present invention.

FIG. 2 illustrates a scanner as a computer peripheral connected to a computer according to another embodiment of the present invention.

FIG. 3 is a flowchart of a method according to another embodiment of the present invention.

FIG. 4 is a flowchart of a method for creating a scan template according to another embodiment of the present invention.

FIG. 5 is a block diagram of a digital transmitter according to another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

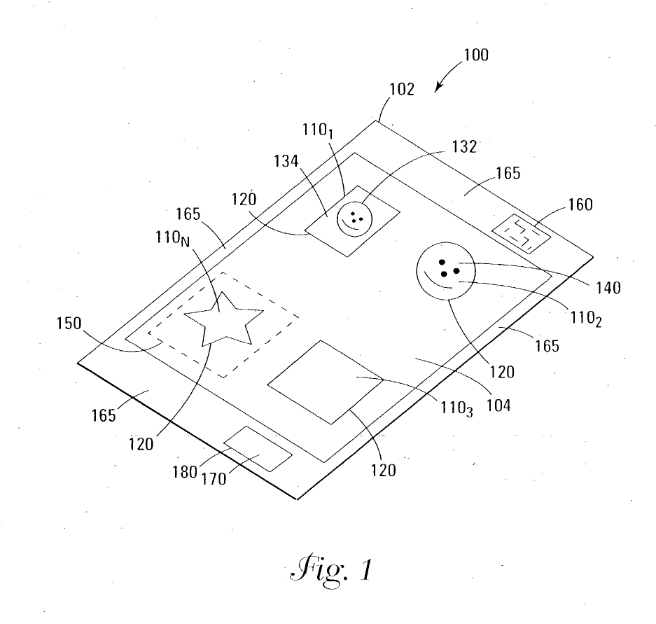

FIG. 1 illustrates a scan template 100 according to an embodiment of the present invention. Template 100 includes a media sheet 102, e.g., a paper sheet, that has FIGS. 110₁ to 110_{N} printed thereon. FIGS. 110₁ to 110_{N} can be of the same or different shapes. One or more of FIGS. 110 receives a hardcopy image, such as a printed image, photograph, drawing, text document, etc., thereon. More specifically, a hardcopy image is placed on one or more of FIGS. 110 so as to overlay the corresponding one or more FIGS. 110. For one embodiment, the hardcopy image, such as image 132, is smaller than the FIG. 110, such as FIG. 110₁, and is contained entirely within FIG. 110₁. For another embodiment, the hardcopy image, such as image 140, is substantially the same size and shape as the FIG. 110, such as FIG. 110₂. For some embodiments, the image, as indicated by a dashed line 150, is larger than the FIG. 110, such as FIG. 110_{N}, and the hardcopy image covers FIG. 110_{N}, as shown in FIG. 1. For other embodiments, the image is a photograph that matches the FIG. 110. For one embodiment, each of FIGS. 110 includes an adhesive for adhering a hardcopy image thereto. For another embodiment, the adhesive enables a hardcopy image to be removably attached to a FIG. 110 so that the hardcopy image can be repositioned if necessary.

A machine-readable identifier 160, such as a barcode, is disposed on media sheet 102, e.g., adjacent an edge of media sheet 102, such as within a margin 165 of media sheet 102. For one embodiment, identifier 160 contains information that specifies each of FIGS. 110, such as the location, size, and shape of each of FIGS. 110. For another embodiment, the location, size, and shape of each of FIGS. 110 are encoded in identifier 160 using a graphics language, such as Hewlett Packard Graphics Language (HPGL) manufactured by the Hewlett-Packard Company, Palo Alto, Calif., U.S.A. For one embodiment identifier 160 is an encoded graphics language, such as HPGL. For some embodiments, identifier 160 is integral with template 100 or is attached to template 100, e.g., by an adhesive or the like.

When a scanner scans template 100, the scanner detects machine-readable identifier 160, and the scanner removes a region 104 of media sheet 102 that lies outside of the boundaries 120 of FIGS. 110 from media sheet 102 according to the specifications of FIGS. 110 encoded in machine-readable identifier 160, thus leaving FIGS. 110. More specifically, the scanner deletes an electronic representation of region 104 from an electronic representation of a scanned image corresponding to media sheet 102 so as to retain electronic representations of FIGS. 110. The scanner then creates data files corresponding to FIGS. 110. For example, the data file corresponding to FIG. 110₁ includes image 132 and a portion 134 of FIG. 110₁ that surrounds image 132. The data file corresponding to FIG. 110₂ includes image 140 only. The data file corresponding to FIG. 110_{N} includes only the portion of image 150 corresponding to FIG. 110_{N}, e.g., a star-shaped figure. The remaining portion of image 150 is included in region 104 and is deleted.

For one embodiment, a scanner cannot detect boundary line 120 so that boundary line 120 does not appear in the electronic representation of the scanned image. This means that the boundary line will not appear, for example, when the scanned image is displayed on a computer monitor, when the scanned image is printed, etc.

For another embodiment, identifier 160 includes one or more destination addresses on a data network. For some embodiments, one or more of the destination addresses are linked to one or more of the FIGS. 110 so that after template 100 is scanned, data corresponding to a FIG. 110 is sent to the destination address (or addresses) corresponding to the FIG. 110. For another embodiment, the destination addresses are network addresses of network devices (printers, servers, workstations, etc.), electronic messaging addresses (e.g., email), facsimile (fax) numbers, etc. For another embodiment, the data network is a Local Area Network, the Internet, or the like.

For other embodiments, the destination addresses are included in a machine-readable identifier 170, such as a barcode, located on template 100, e.g., adjacent the same edge of template 100 as identifier 160 or a different edge of template 100 than identifier 160, as shown in FIG. 1, such as within margin 165 of template 100. For one embodiment, identifier 170 is contained on a sticker that is attached to template 100 at geometrical region 180 of template 100, e.g., by a user of template 100. For another embodiment, identifier 160 includes information that specifies geometrical region 180, such as the location, the size, and, for some embodiments, the shape of geometrical region 180. For another embodiment, geometrical region 180 contains an adhesive for adhering identifier 170 thereto.

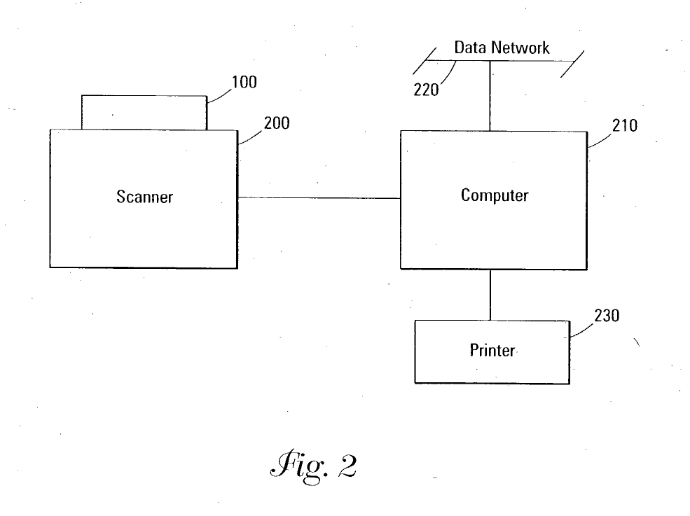

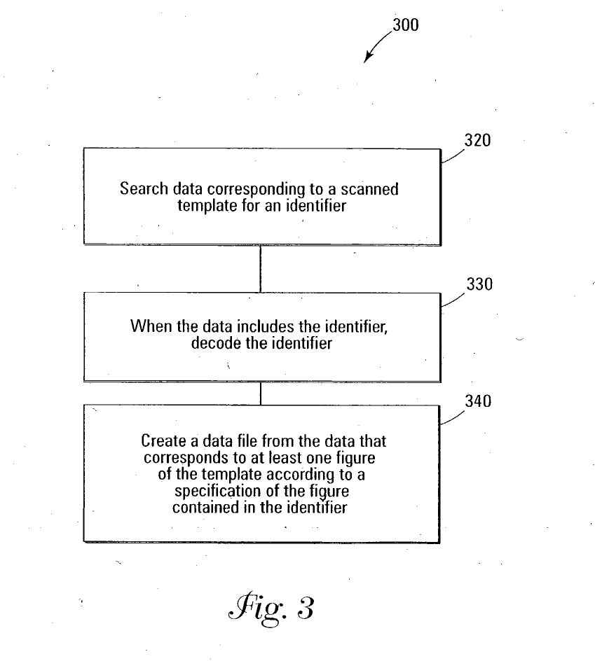

FIG. 2 illustrates a scanner 200 as a computer peripheral connected to a computer 210 according to another embodiment of the present invention. For one embodiment, scanner 200 scans in template 100, including identifier 160 and, for other embodiments, identifier 170. Scanner 200 converts template 100 into digital data and sends the digital data to computer 210. Computer-readable instructions that are supplied to a user of computer 210 on a removable computer-usable medium, such as a compact disc read-only memory (CD-ROM), are, for example, stored on a hard drive of computer 210. For one embodiment, the computer-readable instructions are adapted to cause computer 210 to perform a method 300, as illustrated by the flowchart in FIG. 3.

At block 320, computer 210 searches the data corresponding to template 100 for identifier 160. This may include looking for a predetermined indicator, such as a code that may be numbers, letters, alphanumeric, or other scanner detectable indicia, within the data corresponding to template 100, e.g., within margin 165. When the data corresponding to template 100 includes identifier 160, computer 210 decodes identifier 160 at block 330.

At block 340, a data file is created from the data corresponding to template 100 that corresponds to at least one of FIGS. 110 according to a specification of the region 110 contained in identifier 160. For some embodiments, computer 210 converts data that corresponds to the FIG. 110 to a bitmap data file. For other embodiments, computer 210 converts the data into other types of formatted data files, such as Portable Document Format (PDF), Tag Image File Format (TIFF), Joint Photographic Experts Group (JPEG), or other data format, for example, from the bitmap data file. For one embodiment, identifier 160 includes the type of data format, and computer 210 converts the data to that format without user intervention.

Identifier 160 can include a different data format for data corresponding to each of the FIGS. 110 so that the data corresponding to each of the FIGS. 110 can be converted to a different data format. Alternatively, identifier 160 can include multiple data formats for the data corresponding to a single FIG. 110 so that the data corresponding to the FIG. 110 can be converted to multiple data formats. For one embodiment, identifier 160 includes different data formats for different groups of FIGS. 110, e.g., one data format for a group of FIGS. 110 having FIGS. 110₁ and 110₂ and a different data format for a group of FIGS. 110 having FIGS. 110₃ to 110_{N}, etc. For another embodiment, computer 210 prompts the user to select a data format for each of FIGS. 10.

For one embodiment, computer 210 is connected to a data network 220, such as the data network described above. For this embodiment, computer 210 sends one or more of the data files respectively corresponding to one or more FIGS. 110 to one or more of the destination addresses specified in identifier 160 or identifier 170. For another embodiment, computer 210 accesses the destination addresses of identifier 170 by locating identifier 170. For one embodiment, this involves computer 210 searching for identifier 170 by looking for a predetermined indicator, such as a code that may be numbers, letters, or alphanumeric, within the data corresponding to template 100, e.g., within margin 165, in response to an instruction encoded in identifier 160. For another embodiment, locating identifier 170 involves going to region 180 according to information contained in identifier 160 that specifies geometrical region 180 and looking for the predetermined indicator within the data corresponding to template 100 within geometrical region 180. For some embodiments, the user inputs the destination addresses into computer 210 or selects the destination addresses from a list of destination addresses stored in computer 210. For other embodiments, computer 210 prompts the user to input or select the destination addresses.

For one embodiment, a printer 230 is connected to computer 210. For another embodiment, printer 230 is a network printer located on network 220. For these embodiments, a destination address of indicator 160 or 170 corresponds to printer 230 so that computer 210 sends data corresponding to one or more of FIGS. 110 to printer 230. For other embodiments, the user elects to print the data corresponding to one or more FIGS. 110 at printer 230, e.g., in response to being prompted by computer 210.

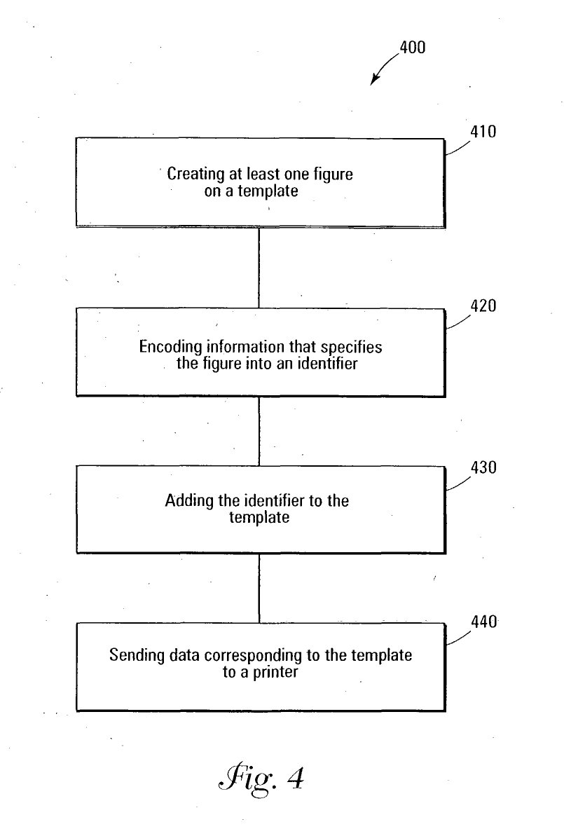

For one embodiment, computer 210 performs a method 400 for creating template 100 in response to user inputs, as illustrated by the flowchart in FIG. 4 according to another embodiment of the present invention. For one embodiment, method 400 is initiated when a user selects an option, e.g., a “wizard,” provided by the computer-readable instructions of computer 210. At least one of FIGS. 110 is created on template 100 at block 410. For one embodiment, FIG. 110 is created on template 100 in response to the user selecting a predefined shape from a menu and positioning and, for another embodiment, scaling the predefined shape on an electronic representation of template 100 displayed on computer 210, e.g., by dragging the shape using a pointing device, such as a mouse. For another embodiment, the user draws FIG. 110 on the electronic representation of template 100 using a computer graphics package installed on or accessible to computer 210.

At block 420, computer 210 encodes information that specifies FIG. 110 into identifier 160. For one embodiment, the information includes the location of FIG. 110 on template 100 and the size and shape of FIG. 110. For another embodiment, encoding the information is accomplished by encoding language of the graphics package used to create FIG. 110 into identifier 160. For one embodiment, this involves encoding language of the graphics package into a barcode format. For another embodiment, Hewlett Packard Graphics Language is encoded into a barcode format. Identifier 160 is added to template 100 at block 430, i.e., data corresponding to identifier 160 is added to data corresponding to template 100. At block 440, the data corresponding to template 100, including identifier 160, is sent to printer 230. Printer 230 then prints out template 100.

For one embodiment, computer 210 encodes the destination addresses into identifier 160. For another embodiment, the user inputs the destination addresses into computer 210, e.g., in response to being prompted by computer 210. For another embodiment, computer 210 encodes the predetermined indicator for locating identifier 170 into identifier 160. For some embodiments, computer 210 adds geometrical region 180 to template 100 for identifier 170. This may be in response to the user selecting an option from a menu of computer 210, e.g., in response to being prompted by computer 210. For other embodiments, computer 210 encodes information that specifies geometrical region 180 in identifier 160, such as the location of geometrical region 180 on template 100, the size and, for some embodiments, the shape of geometrical region 180. For another embodiment, computer 210 encodes the instruction into identifier 160 for locating identifier 170. For one embodiment, computer 210 encodes the type (or types) of data formatting for each of FIGS. 110 into identifier 160. This may be in response to the user selecting an option from a menu of computer 210, e.g., in response to being prompted by computer 210.

For some embodiments, computer 210 creates a template with at least one geometrical region for receiving a hardcopy image thereon, such as region 110 of template 100 of FIG. 1; and without a machine-readable identifier, such as identifier 160 of FIG. 1, and sends data corresponding to the template to printer 230. Printer 230 prints out the template without the machine-readable identifier. For these embodiments, computer 210 creates the machine-readable identifier, as described above for identifier 160, and sends the machine-readable identifier to printer 230. Printer 230 prints out the machine-readable identifier, and a user attaches the machine-readable identifier to the template, e.g., by gluing or the like.

For other embodiments, computer 210 creates identifier 170 by encoding the destination addresses into identifier 170. Computer 210 sends identifier 170 to printer 230. Printer 230 prints identifier 170, and a user attaches identifier 170 to template 100 at region 180, e.g., by gluing or the like.

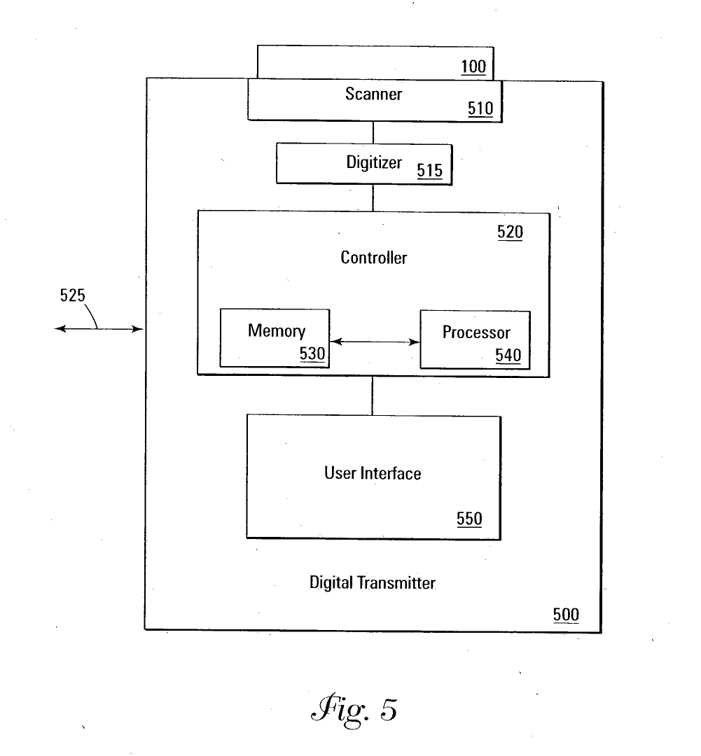

FIG. 5 is a block diagram of a digital transmitter 500, such as a digital sender, digital network copier, multi-function peripheral, etc., according to another embodiment of the present invention. Digital transmitter 500 includes a scanner 510 connected to a controller 520. For one embodiment, scanner 510 scans in template 100, including identifier 160, and, for other embodiments, identifier 170. A digitizer 515, such as an analog-to-digital converter, is connected between scanner 510 and controller 520. Scanner 510 converts template 100 into analog electrical signals corresponding to template 100. Digitizer 515 receives the analog electrical signals from scanner 510 and converts the analog electrical signals into digital data. Digitizer 115 sends the digital data to controller 520. For one embodiment, a first portion of the digital data corresponds to at least one FIG. 110; a second portion of the digital data corresponds to identifier 160; and, in embodiments having identifier 170, a third portion of the digital data corresponds to identifier 170.

For one embodiment, controller 520 is adapted to format the data received from digitizer 515 into a bitmap format. For other embodiments, controller 520 converts the data into a formatted data file, such as Portable Document Format (PDF), Tag Image File Format (TIFF), Joint Photographic Experts Group (JPEG), or other data format, for example, from the bitmap format. For one embodiment, controller 520 is adapted to transmit digital data corresponding to template 100, e.g., as a formatted data file, via an interface 525 to a data network, such as described above.

Controller 520 includes a memory 530, e.g., a computer-usable storage media that can be fixedly or removably attached to digital transmitter 500. Some examples of computer-usable media include static or dynamic random access memory (SRAM or DRAM), read-only memory (ROM), electrically-erasable programmable ROM (EEPROM or flash memory), magnetic media and optical media, whether permanent or removable. Memory 530 may include more than one type of computer-usable media for storage of differing information types.

In various embodiments, memory 530 stores digital data received from digitizer 515 for subsequent formatting by controller 520. For another embodiment, memory 530 contains computer-readable instructions, e.g., drivers, adapted to cause a processor 540 of controller 520 to format the data received from digitizer 515 and computer-readable instructions to cause processor 540 to cause digital transmitter 500 to perform various methods, as described below. For one embodiment, digital transmitter 500 includes a user interface 550.

For various embodiments, the computer-readable instructions of digital transmitter 500 cause digital transmitter 500 to perform method 300, as described above. That is, digital transmitter 500 searches the data corresponding to template 100 for identifier 160 at block 320, decodes identifier 160 at block 330 when the data corresponding to template 100 includes identifier 160, and creates a data file from the data that corresponds to at least one of FIGS. 110 according to a specification of the FIG. 110 contained in identifier 160 at block 340. For another embodiment, digital transmitter 500 converts data corresponding to each of FIGS. 110 to a different data format or data corresponding to a single FIG. 110 to multiple data formats based on information contained in identifier 160. For some embodiments, searching for identifier 160 includes looking for a predetermined indicator, such as a code that may be numbers, letters, or alphanumeric, within the data corresponding to template 100, e.g., within margin 165.

For one embodiment, digital transmitter 500 sends one or more of the data files respectively corresponding to one or more FIGS. 110 to one or more of the destination addresses specified in identifier 160 or identifier 170. For another embodiment, digital transmitter 500 accesses the destination addresses of identifier 170 by locating identifier 170. For one embodiment, this involves digital transmitter 500 searching for identifier 170 by searching for a predetermined indicator, such as a code that may be numbers, letters, alphanumeric, or other scanner detectable indicia, within the data corresponding to template 100, e.g., within margin 165, in response to an instruction encoded in identifier 160. For another embodiment, locating identifier 170 involves going to region 180 according to information contained in identifier 160 that specifies geometrical region 180 and searching for the predetermined indicator within the data corresponding to template 100 within geometrical region 180. For some embodiments, the user inputs the destination addresses from user interface 550 of digital transmitter 500 or selects the destination addresses from a list of destination addresses stored in memory 530. For other embodiments, digital transmitter 500 prompts the user to input or select the destination addresses.

### Conclusion

Although specific embodiments have been illustrated and described hereinit is manifestly intended that this invention be limited only by the following claims and equivalents thereof.

1. A scan template, comprising:
a media sheet having printed thereon a figure; and
a machine-readable identifier disposed on the media sheet specifying a size, shape, and location on the sheet of the figure.

2. The scan template of claim 1, wherein the figure comprises a plurality of figures and the identifier comprises a single identifier identifying a size, shape, and location on the sheet of each of the figures.

3. The scan template of claim 1, wherein the identifier comprises an identifier identifying a size, shape, and location on the sheet of the figure and a destination to which an image scanned from the template will be transmitted.

4. The scan template of claim 1, wherein the first machine-readable identifier further comprises one or more data formats for data corresponding to the figure.

5. A scan template, comprising:
a media sheet;
a figure printed on the sheet;
a first machine-readable identifier on the sheet identifying a size, shape, and location on the sheet of the figure; and
a second machine-readable identifier on the sheet identifying a destination to which an image scanned from the template will be transmitted.

6. The scan template of claim 5, wherein the identifiers are printed on the sheet.

7. The template of claim 5, wherein the identifiers are affixed to the sheet.

8. The scan template of claim 5, wherein the first machine-readable identifier specifies the location of the second machine-readable identifier.

9. A scan template comprising:
a means for receiving a hardcopy image thereon for scanning; and
a means for specifying a location, size, and shape of the receiving means.

10. The scan template of claim 9, further comprising a means for specifying one or more data formats for data corresponding to the receiving means.

11. The scan template of claim 9, further comprising a means for specifying one or more destination addresses for receiving data corresponding to the receiving means.

12. A computer-usable media containing computer-readable instructions for printing on a sheet a figure and a machine-readable identifier specifying a size, shape, and location on the sheet of the figure.

13. The computer-usable media of claim 12, wherein the instructions for printing a figure comprise instructions for printing a plurality of figures and the instructions for printing a machine-readable identifier comprise instructions for printing a single identifier identifying a size, shape, and location on the sheet of each of the figures.

14. The computer-usable media of claim 12, wherein the instructions for printing a machine-readable identifier comprise instructions for printing an identifier identifying a size, shape, and location on the sheet of the figure and a destination to which an image scanned from the template will be transmitted.

15. A computer-usable media containing computer-readable instructions for printing on a sheet:
a figure;
a first machine-readable identifier identifying a size, shape, and location on the sheet of the figure; and
a second machine-readable identifier identifying a destination to which an image scanned from the template will be transmitted.

16. A computer-usable media containing computer-readable instructions for causing a digital transmitter to perform a method, wherein the method comprises:
decoding a first machine-readable identifier of a template scanned into the digital transmitter, wherein the first machine-readable identifier is contained within data corresponding to the template; and
creating a data file from a portion of the data corresponding to the template that corresponds to a a figure printed on the template, wherein the first machine-readable identifier specifies a size, shape, and location on the template of the figure.

17. The computer-usable media of claim 16, wherein the method further comprises sending the data file to one or more destination addresses specified in the first machine-readable identifier.

18. The computer-usable media of claim 16, wherein the method further comprises locating a second machine-readable identifier of the template according to information contained in the first machine-readable identifier, wherein the second machine-readable identifier comprises one or more destination addresses for receiving the data file.

19. The computer-usable media of claim 18, wherein the method further comprises sending the data file to the one or more destination addresses specified in the second machine-readable identifier.

20. The computer-usable media of claim 16, wherein the method further comprises formatting the data file into one or more data formats specified in the first machine-readable identifier.

21. A computer-usable media containing computer-readable instructions for causing a computer to perform a method for creating a scan template, the method comprising:
creating a figure on the scan template;
encoding information that specifies a size, shape, and location on the scan template of the figure into a first machine-readable identifier;
adding the first machine-readable identifier to the scan template; and
sending data corresponding to the scan template, including data corresponding to the first machine-readable identifier, to a printer.

22. The computer-usable media of claim 21, wherein the method further comprises before sending the data corresponding to the scan template to the printer:
encoding one or more destination addresses for receiving data corresponding to the figure into a second machine-readable identifier;
adding the second machine-readable identifier to the scan template; and
encoding information into the first machine-readable identifier that specifies the location of the second machine-readable identifier on the scan template.

23. The computer-usable media of claim 21, wherein the method further comprises encoding one or more destination addresses for receiving data corresponding to the figure into the first machine-readable identifier.

24. The computer-usable media of claim 21, wherein the method further comprises encoding one or more data formats for data corresponding to the figure into the first machine-readable identifier.

25. A digital transmitter comprising:
a scanner; and
a controller connected to the scanner, the controller adapted to cause the digital transmitter to perform a method, the method comprising:
decoding a machine-readable identifier of a template scanned into the digital transmitter by the scanner, wherein the machine-readable identifier is contained within data corresponding to the template that is received at the controller from the scanner; and
creating a data file from a portion of the data corresponding to the template that corresponds to a figure printed on the template, wherein the first machine-readable identifier specifies a size, shape, and location on the template of the figure.

26. A digital copier comprising:
a scanner;
a digitizer connected to the scanner; and
a controller connected to the digitizer, the controller adapted to cause the digital copier to perform a method, the method comprising:
decoding a first machine-readable identifier of a template scanned into the digital copier by the scanner, wherein the first machine-readable identifier is contained within data corresponding to the template that is received at the controller from the digitizer; and
creating a data file from a portion of the data corresponding to the template that corresponds to a figure printed on the template, wherein the first machine-readable identifier specifies a size, shape, and location on the template of the figure.
